(19) United States
(12) Patent Application Publication
(10) Pub. No.: US 2010/0091486 A1
(43) Pub. Date: Apr. 15, 2010

(54) INTERNAL CIRCULATION MECHANISM FOR AN AIR-TIGHT LED LAMP

(76) Inventor: Jiahn-Chang WU, Hsinchu (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/328,817

(22) Filed: Dec. 5, 2008

(30) Foreign Application Priority Data
Oct. 11, 2008 (TW) 097143292

(51) Int. Cl. F21V 29/02

(52) U.S. Cl. 362/234; 362/373

(57) ABSTRACT

A plurality of LED lamps are mounted on a substrate and sealed within a lamp house to form a closed LED lamp. A circulation fan is installed inside the air-tight LED lamp, with the guidance of a sleeve frame which encloses at least partial of the fan to form partial portion of an air circulation path. An air inlet is made on the sleeve frame behind or in the lateral of the fan, and an air outlet is made on the frame before the fan. The air circulates between inside the sleeve frame and outside the sleeve frame within the sealed lamp housing so as to make the temperature even distribution inside the lamp.

### RELATED APPLICATIONS

The present application is based on, and claims priority from, Taiwan Application Serial Number 097143292, filed Nov. 10, 2008, the disclosure of which is hereby incorporated by reference herein in its entirety.

### FIELD OF THE INVENTION

This invention relates to a light emitted lamp, especially to a closed system of a light emitted lamp which has even heat distribution inside the lamp.

### DESCRIPTION OF THE RELATED ART

A prior art of an air-tight lamp is shown in FIG. 1, which never seems to have an internal circulation inside the lamp. A plurality of light emitted diode (LED) 10 is mounted on a first side of a substrate 11. As shown in FIG. 1, an air-tight housing 18 encloses the LED 10 for protection against dust or water intrusion. However the temperature uneven distribution occurs around the LED 10 on the substrate 11. LED 10 generates heat during operation; the substrate 11 is not a good heat conductor. The temperature near the LED 10 gets higher and higher. The light output from LED 10 light sources decrease with increasing temperature. The local higher temperature sometimes even causes failure of the LED 10. Improved designs have been proposed but all focus on heat dissipation device mounted on the outside surface of the air-tight housing 18, however such improvement still does not solve the temperature uneven distribution problem around the LED 10 and hence the light efficiency and lifetime for the traditional LED lamp does not meet the expected requirement nowadays.

### SUMMARY OF THE INVENTION

The invention discloses an internal circulation mechanism for an air-tight LED lamp. A circulation fan is installed inside the air-tight LED lamp, the circulation fan is configured near the substrate so as to bring away the heat generated around the substrate. A sleeve frame divides two portions inside the lamp—inside and outside of the sleeve frame. A circulation path can be formed when the fan is running so as to change the air between inside the sleeve frame and outside the sleeve frame. The temperature inside the lamp can be evenly distributed and no more local superheating inside the air-tight LED lamp.

A first object of this invention is to set up an internal circulation mechanism in an air-tight LED lamp to even the temperature distribution inside the LED lamp. A second object of this is invention is to set up an internal circulation mechanism to take away accumulated heat around light diodes in an air-tight LED lamp.

### BRIEF DESCRIPTION OF THE DRAWINGS

FIG. 1. a prior art.

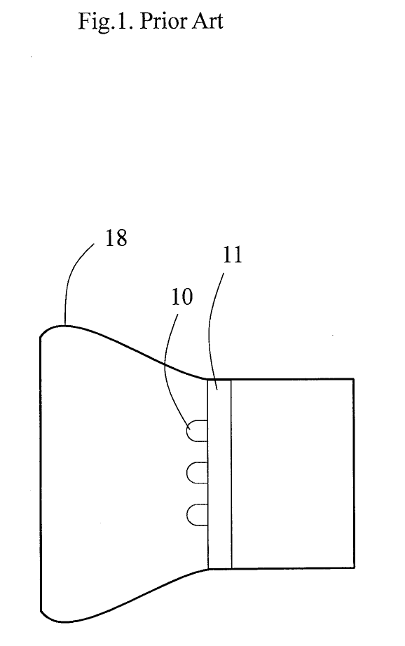

FIG. 2. a first embodiment of the invention

FIG. 3. a second embodiment of the invention

FIG. 4. a third embodiment of the invention

FIG. 5. a fourth embodiment of the invention

FIG. 6. a fifth embodiment of the invention

FIG. 7. a sixth embodiment of the invention

FIG. 8. an eighth embodiment of the invention

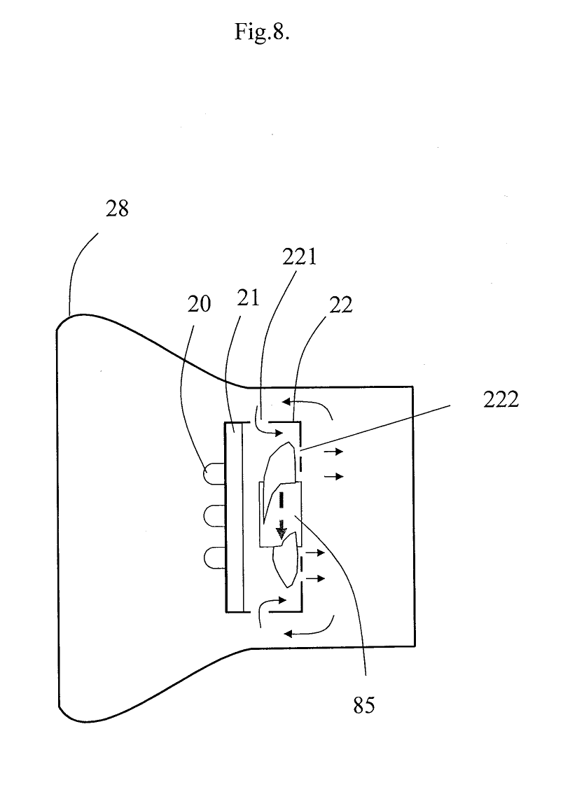

### DETAILED DESCRIPTION OF THE PREFERRED EMBODIMENTS

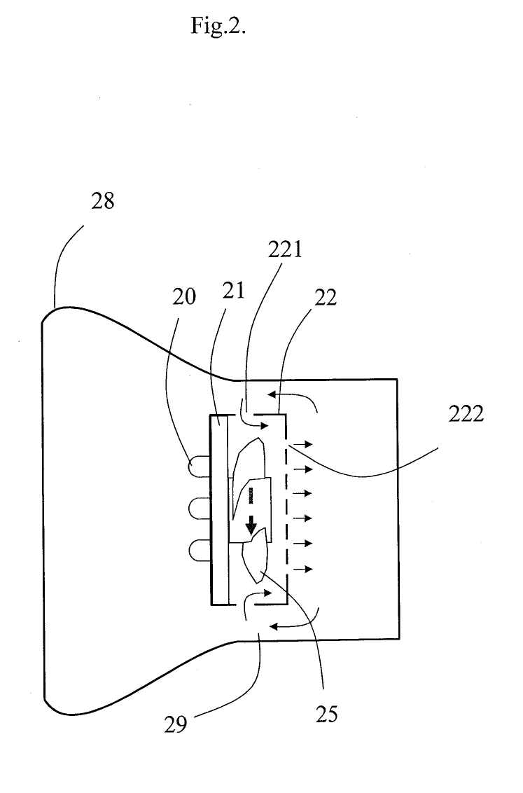

FIG. 2 shows a first embodiment of this invention. A substrate 21 has a first side and a second side. A plurality of LEDs 10 is mounted on the first side of the substrate 21; a fan 25 is mounted near the second side of the substrate 21. The fan 25 blows away from the substrate 21 to bring away the heat generated by the LED 20 mounted on the substrate 21. A sleeve frame 22 encloses the fan 25. Air inlets 221 are made in the lateral of the fan 25, and air outlets 222 are made in front of the fan 25. A housing 28 encloses air-tightly the LED 20, substrate 21, the fan 25 and the sleeve frame 22. The sleeve frame 22 installed in the middle of the lamp to leave spaces 29 between it and the housing 28. An air circulation path is formed in between the inside and outside of the sleeve frame 22; space 29 is a portion of the circulation passage. The internal circulation mechanism results in an even temperature distribution inside the housing 38.

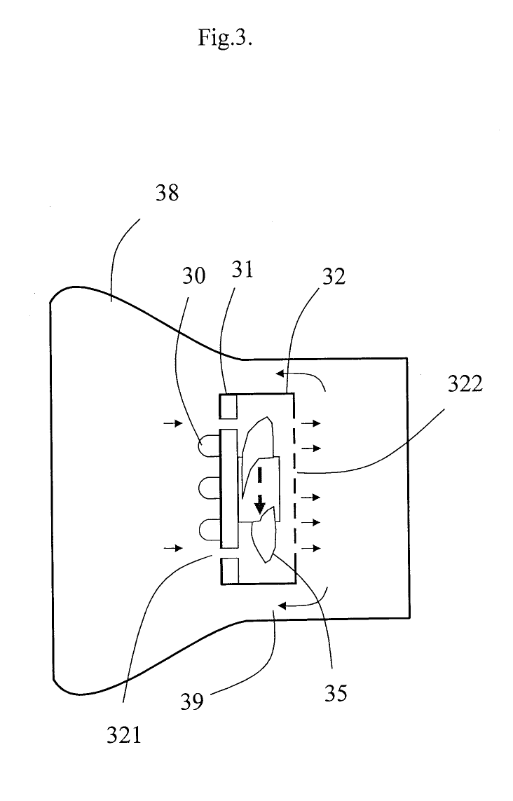

FIG. 3 shows a second embodiment of this invention. A substrate 31 has a first side and a second side. A plurality of LEDs 30 is mounted on the first side of the substrate 31; a fan 35 is mounted near the second side of the substrate 31. The fan 35 blows away from the substrate 31 to bring away the heat generated by the LED 30 mounted on the substrate 31. A sleeve frame 32 encloses the fan 35. Air inlets 321 are made in the substrate 31, and air outlets 322 are made in front of the fan 35. A housing 38 encloses air-tightly the LED 30, substrate 31, the fan 35 and the sleeve frame 32. The sleeve frame 32 installed in the middle of the lamp to leave spaces 39 between it and the housing 38. An air circulation path is formed in between the inside and outside of the sleeve frame 32; space 39 is a portion of the circulation passage. The internal circulation mechanism results in an even temperature distribution inside the housing 38.

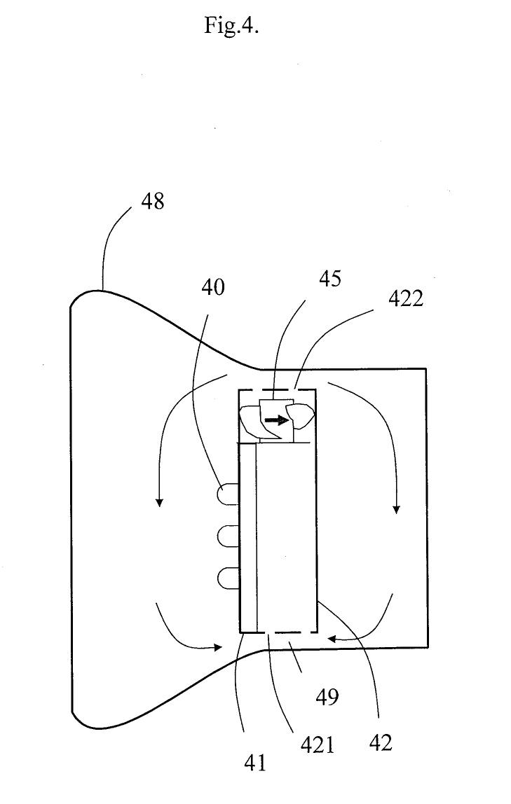

FIG. 4 shows a third embodiment of this invention. A substrate 41 has a first side and a second side. A plurality of LEDs 40 is mounted on the first side of the substrate 41; a fan 45 is mounted on a lateral side of the substrate 41. The fan 45 blows laterally away from the substrate 41 to bring away the heat generated by the LED 40 mounted on the substrate 31. A sleeve frame 42 encloses the fan 45. Air inlets 421 are made in the sleeve frame 42 on a side opposite to the fan side, and air outlets 422 are made in front of the fan 45. A housing 48 encloses air-tightly the LED 40, substrate 41, the fan 45 and the sleeve frame 42. The sleeve frame 42 installed in the middle of the lamp to leave spaces 49 between it and the housing 48. An air circulation path is formed in between the inside and outside of the sleeve frame 42; space 39 is a portion of the circulation passage. The internal circulation mechanism results in an even temperature distribution inside the housing 48. Air inlets 421 can be made in the sleeve frame 42 on a lateral side other than the fan side according to design choices.

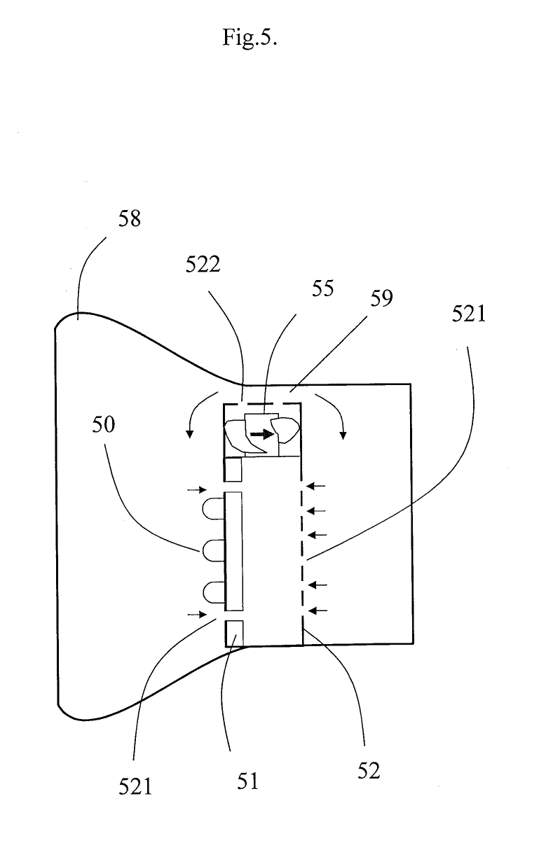

FIG. 5 shows a fourth embodiment of this invention. A substrate 51 has a first side and a second side. A plurality of LEDs 50 is mounted on the first side of the substrate 51; a fan 55 is mounted on a lateral side of the substrate 51. The fan 55 blows laterally away from the substrate 41 to bring away the heat generated by the LED 50 mounted on the substrate 51. A sleeve frame 52 encloses the fan 55. Air inlets 521 are made in the sleeve frame 52 on a side other than the fan side, and air outlets 522 are made in front of the fan 55. A housing 58 encloses air-tightly the LED 50, substrate 51, the fan 55 and the sleeve frame 52. The sleeve frame 52 installed on the bottom of the lamp to leave spaces 59 on top and/or lateral side of it and the housing 58. An air circulation path is formed in between the inside and outside of the sleeve frame 52; space 59 is a portion of the circulation passage. The internal circulation mechanism results in an even temperature distribution inside the housing 58.

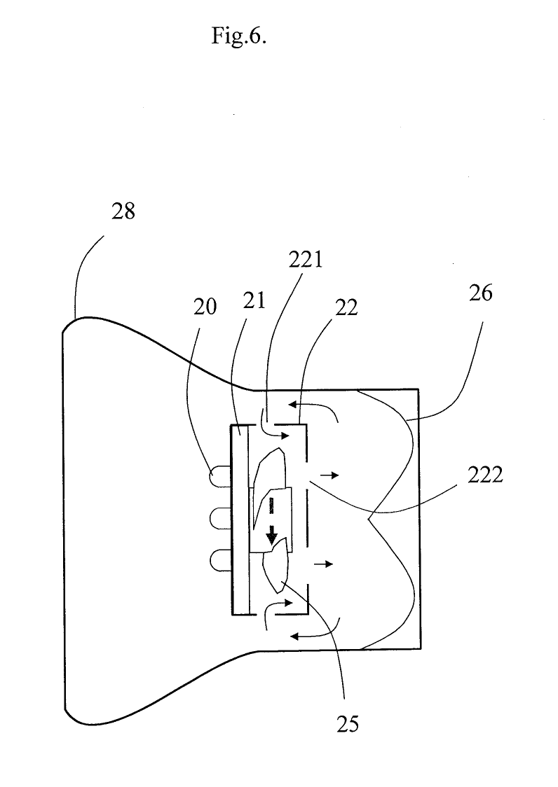

FIG. 6 shows a fifth embodiment of this invention. This design is similar to the first embodiment as shown in FIG. 2. but to add an air-guidance plate 26 in front of the outlet 222 to guide the air exiting out of the outlet 222 to turn in order to obtain a smooth circulation.

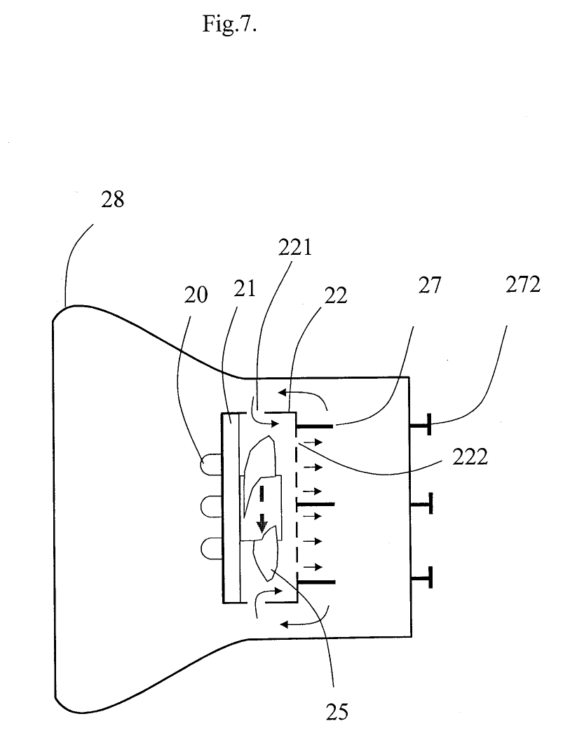

FIG. 7 shows a sixth embodiment of this invention. This design is similar to the first embodiment as shown in FIG. 2. but to add a first fin type dissipation metal 27 on the outside of the outlet 222 to help heat dissipation of the sleeve frame 22 inside the lamp housing 28. A second fin type dissipation metal 272 can be made on the outside of the housing 28 to help heat dissipation of the lamp housing 28.

shows a sixth embodiment of this invention. This design is similar to the first embodiment as shown in FIG. 2. but to install the fan 85 partially inside and partially outside of the sleeve frame 22 to save space occupied by the sleeve frame 22.

While several embodiments have been described by way of example, it will be apparent to those skilled in the art that various modifications may be made in the embodiments without departing from the spirit of the present invention. Such modifications are all within the scope of the present invention, as defined by the appended claims.

What is claimed is:

1. An internal circulation mechanism for an air-tight LED lamp comprising:
a sleeve frame installed within the lamp; and
a fan being at least partial portion configured inside the sleeve frame such that an air circulation path is formed passing by the LED and circulating the air between inside and outside of the sleeve frame when the fan is running; and
an air-tight housing hermetically enclosing the above elements.

2. An internal circulation mechanism for an air-tight LED lamp as claimed in claim 1, further comprising:
a substrate having a front side and a rear side;
a plurality of LED mounted on the front side;
said sleeve frame being configured on the rear side;
an air inlet for air entering the sleeve and an air outlet for air existing out of the sleeve frame when the fan is running;

3. An internal circulation mechanism for an air-tight LED lamp as claimed in claim 2, wherein said air inlet located on horizontal sides of the sleeve frame; and said air outlet located on a vertical rear side of the sleeve frame.

4. An internal circulation mechanism for an air-tight LED lamp as claimed in claim 2, wherein said air inlet are through holes of the substrate.

5. An internal circulation mechanism for an air-tight LED lamp as claimed in claim 1, further comprising air-guidance plate outside the air outlet.

6. An internal circulation mechanism for an air-tight LED lamp as claimed in claim 1, further comprising heat sink on the outside of the sleeve frame.

7. An internal circulation mechanism for an air-tight LED lamp as claimed in claim 1, further comprising heat sink on the outside of the air-tight housing.
